(19) United States
(12) Patent Application Publication
(10) Pub. No.: US 2006/0058003 A1
(43) Pub. Date: Mar. 16, 2006

(54) Providing wired and wireless voice and data services

(76) Inventor: Il-Hyeong Lee, Suwon-si (KR)

Correspondence Address: Robert E. Bushnell, Suite 300, 1522 K Street, N.W., Washington, DC, 20005-1202, US

(21) Appl. No.: 11/212,772

(22) Filed: Aug. 29, 2005

(30) Foreign Application Priority Data
Sep. 13, 2004 (KR) 2004-73183

(51) Int. Cl. H04Q 7/20; H04M 11/00

(52) U.S. Cl. 455/403; 455/463

(57) ABSTRACT

In a communication terminal system, a system main device (i.e., main phone) terminal has a function of a keyphone main device so that the whole system is compact and the system has a wireless Local Area Network (LAN) Access Point (AP) for wirelessly transmitting and receiving voice and data between terminals controlled by the main device. The communication terminal system includes: at least one wireless LAN phone for transmitting and receiving data to and from a main device via a wireless connection; and the main device having an AP for a wireless connection with the wireless LAN phone, a wireless data processor for processing data transceived via the AP, a Digital Signal Processor (DSP) for converting data transceived via the wireless data processor to a voice signal or vice versa, an analog circuit for connecting the converted signal to an office line, and at least one office line port.

This application makes reference to, incorporates the same herein, and claims all benefits accruing under 35 U.S.C. §119 from an application for COMMUNICATION TERMINAL SYSTEM PROVIDING WIRED AND WIRELESS VOICE AND DATA SERVICES AND SIGNAL CONTROL METHOD THEREOF earlier filed in the Korean Intellectual Property Office on 13 Sep. 2004 and there duly assigned Serial No. 2004-73183.

### BACKGROUND OF THE INVENTION

1. Field of the Invention

The present invention relates to a telephone type system suitable for a small office, and more particularly, to a communication terminal system capable of providing wired and wireless voice and data services and a signal control method thereof, in which a main device and a sub terminal (e.g., a wireless terminal) wirelessly transceives voice and data therebetween and the main device has a small exchange system so that the whole system is compact.

2. Description of the Related Art

As a part of recent clean office phenomenon, a user's desire to remove lines between various communication devices in the office and switch communication between terminals to wireless communication is increasing.

However, an electronic keyphone system, which connects wired phones between staffs in the office via extension or switches the wired phones to an office line, is mainly used in the current office environment.

The current electronic keyphone system includes a main device and a terminal telephone.

The main device connects a terminal telephone to an office line and provides automatic exchange and various system functions.

The terminal telephone transceives data signals from and to the main device using a 4-bit to 32-bit processor and displays a voice call and a current status according to a command of the main device.

The main device is normally a Private Branch Exchange (PBX), and includes a main controller, a signal processor, a subscriber line processor, an exchange, a Dual-Tone Multifrequency (DTMF) transceiver, a ring generator, and a power supply.

The conventional electronic keyphone system, which provides the above-described function, has disadvantages in that it necessarily entails a cable wiring work because the connection between the main device and the terminal telephone are made via lines, and also requires an extension-number change work when staffs' seats are changed due to office layout modification, and the office is not clean due to the presence of cables.

The keyphone system provides only a voice service. For this reason, it is necessary to separately install a Digital Subscriber Line (xDSL) modem or a cable modem, which is provided by a communication service provider, for a data service such as an Internet service.

Furthermore, in order to receive an Internet phone, i.e., Voice over Internet Protocol (VoIP) phone service, it is necessary to purchase a separate Internet phone, or to install an application program for the Internet phone service in a Personal Computer (PC) and provide a headphone and a microphone, which is very inconvenient.

### SUMMARY OF THE INVENTION

It is an object of the present invention to provide a communication terminal system and a signal control method thereof, in which a telephone type terminal functions as a keyphone main device and further provides a data communication service as well as a voice call service so that various functions are incorporated in the system and the whole system is compact.

It is another object of the present invention to provide a communication terminal system having a wireless Local Area Network (LAN) card performing an Access Point (AP) function to wirelessly transceive data between terminals interfacing with a main device (i.e., main phone), and a signal control method thereof.

In order to achieve the objects, a communication terminal system is provided comprising: at least one wireless terminal adapted to transmit and receive data to and from a main device via a wireless connection; and the main device including: an access point adapted to effect a wireless connection with the at least one wireless terminal; a wireless data processor adapted to process data transceived via the access point; a controller adapted to allow the transfer of data from the wireless data processor to a relevant processor depending on a kind of the data; a voice processor adapted to transfer the data to a public switched telephone network upon a determination by the controller that the data is voice data; and a wired data processor adapted to transfer the data to an Internet Protocol network upon a determination by the controller that the data is not voice data.

In order to achieve the objects, a communication terminal system is also provided comprising: at least one wireless local area network phone adapted to transmit and receiving data to and from a main device via a wireless connection; and the main device including: an access point for the wireless connection with the wireless local area network phone; a wireless data processor adapted to process data transceived via the access point; a digital signal processor adapted to convert data transceived via the wireless data processor into a voice signal or vice versa; an analog circuit adapted to transfer the converted signal to an office line; and at least one office line port.

In order to achieve the objects, a signal control method is also provided comprising: receiving, by a call manager, a message coming from at least one of a wireless terminal, a wired telephone arranged in a main device, and a computer connected to a wired Ethernet port; analyzing and converting the received message into a relevant message format; and calling, by the converted message, a relevant message handler to perform a relevant operation.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1A is a schematic view of a communication terminal system which provides voice and data services according to an embodiment of the present invention;

FIG. 1B is a rear view of a main device (i.e., main phone) for a communication terminal system according to the present invention;

FIG. 2 is a detailed block diagram of the main device of FIG. 1;

FIG. 3 is a block diagram of functions related to call process scheduling for implementing the present invention;

FIG. 4 is a view of an extension call method between wireless LAN phones according to an embodiment of the present invention;

FIG. 5 is a view of a call method between a wireless LAN phone and an external telephone terminal via an office line according to an embodiment of the present invention;

FIG. 6 is a view of a method of accessing the Internet using a wireless terminal having a wireless LAN card according to an embodiment of the present invention; and

FIG. 7 is a view of a VoIP telephone call method in a communication terminal system according to an embodiment of the present invention.

### DETAILED DESCRIPTION OF THE INVENTION

The present invention will now be described more fully hereinafter with reference to the accompanying drawings, in which exemplary embodiments of the present invention are shown. The present invention can, however, be embodied in different forms and should not be construed as being limited to the embodiments set forth herein. Rather, these embodiments are provided so that this disclosure will be thorough and complete, and will fully convey the scope of the present invention to those skilled in the art. In the drawings, like numbers refer to like elements.

In embodiments of the present invention, a wireless LAN method is used as an example of a protocol which provides a wireless data communication between a system main device and a wireless terminal, but a wireless protocol of the present invention is not limited to this but can include, for example, other protocol types, such as Bluetooth.

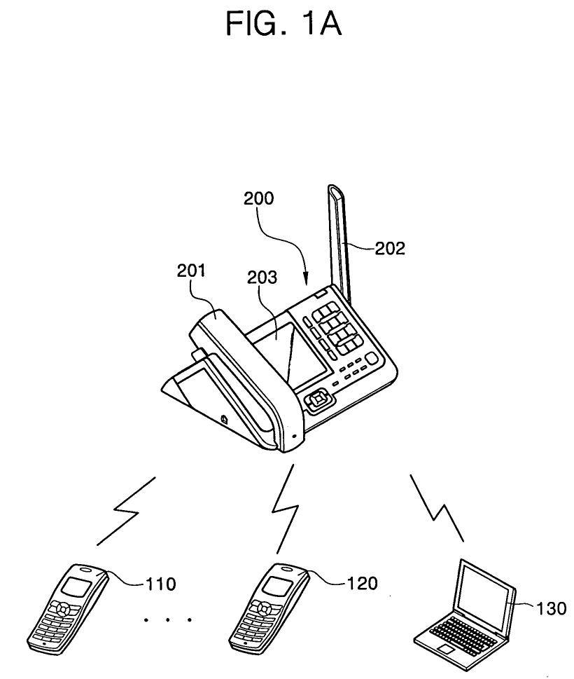

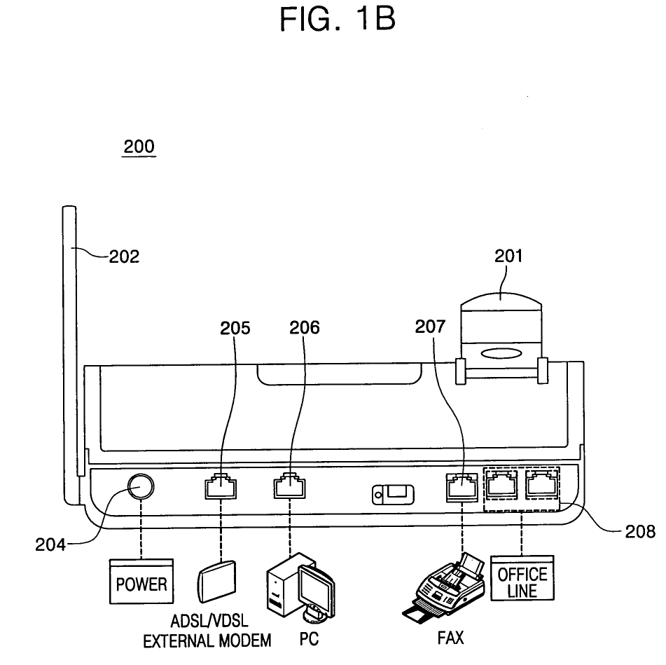

FIG. 1A is a schematic view of a communication terminal system which provides voice and data services according to an embodiment of the present invention.

Referring to FIG. 1A, the communication terminal system includes a main device 200 having a system main phone and a plurality of sub phones 110 and 120.

The main device 200 serves as a PBX and can perform a telephone function (wired telephone function). That is, the main device 200 is a terminal which performs both a main phone function and an exchange function. For the wired telephone function, a handset 201 is installed.

In order to display telephone status information as an additional function, a display 203 can be installed on a top surface of the main device 200.

The main device 200 supports a wireless communication with wireless terminals which support IEEE 802.11 a/b/g and perform a data communication, as well as the plurality of sub phones 110 and 120. That is, the main device 200 is capable of interfacing with a notebook computer 130 having a wireless local area network (LAN) card therein as shown in FIG. 1A.

Here, a wireless connection is established via an access point 202 which interworks with the wireless LAN card.

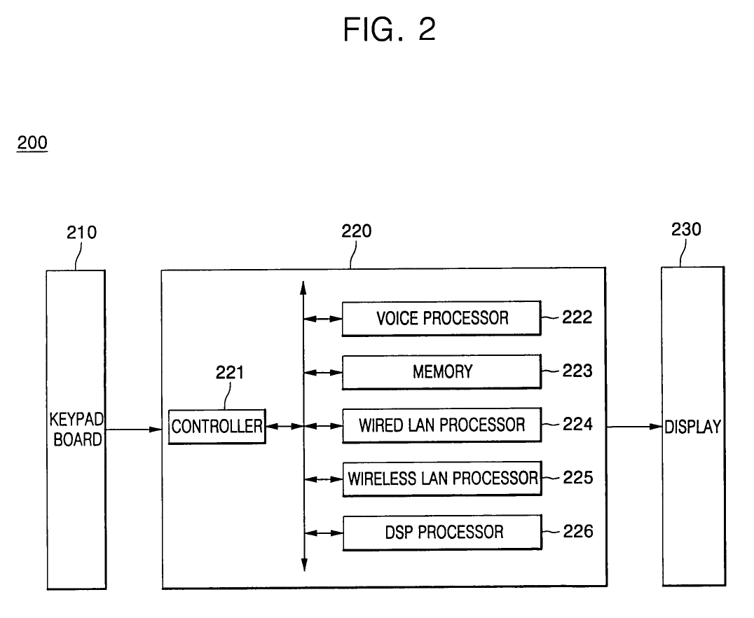

The main device 200, as shown in FIG. 2, is composed of a keypad board 210, a main board 220, and a display 230.

FIG. 1B is a rear view illustrating a main device (main phone) of a communication terminal system according to the present invention.

Referring to FIG. 1B, on the rear of the main device 200, a power supply port 204, an Ethernet port IN 205 for an Internet connection, an Ethernet port OUT 206 for a computer connected for receiving an internet service provided via the Ethernet port IN 205 by a line, a facsimile port 207 for a connection with a facsimile, and two office line ports 208 for interfacing with a PSTN are arranged.

As such, the communication terminal system provides an external call service via two lines, a facsimile service, and a data communication service via the Ethernet port OUT 206 which is connected to the computer.

The internal configuration of the main device implementing the above-described functions is explained below.

FIG. 2 is a detailed block diagram of the main device of FIG. 1.

The main device 200 includes a keypad board 210, a main board 220, and a display 230.

The keypad board 210 scans key values of various function keys as well as 3 by 4 keys and transfers them to the main board 220.

The main board 220 determines a telephone number based on the scanned key values and originates a call to a destination telephone terminal.

The display 230, which can employ a Liquid Crystal Display (LCD) device, displays the current status of respective telephone terminals and the main phone. For example, it displays a busy status, Caller Identification (CID) information, a message, a calendar, a current time, etc. The main board 220 supplies 4-bit graphic data and a clock to the display 230 via a Flexible Flat Cable (FFC).

The main board 220 includes a controller 221 which controls the whole system, a voice processor 222 which transfers a call voice to an office line port, a memory 223, a wireless LAN processor 225 which processes data transceived via an access point, a wired LAN processor 224 which is used when data received from the wireless LAN processor 225 or data transmitted from a computer connected to an Internet are provided via an Internet service, and a Digital Signal Processor (DSP) 226 which converts a voice signal to a data signal or vice versa.

Data of the respective processors are received and transmitted via a Peripheral Component Interconnect (PCI) connector.

The access point supports IEEE 802.11 a/b/g and thus interfaces with a PC or a wireless LAN phone which supports IEEE 802.11 b/g.

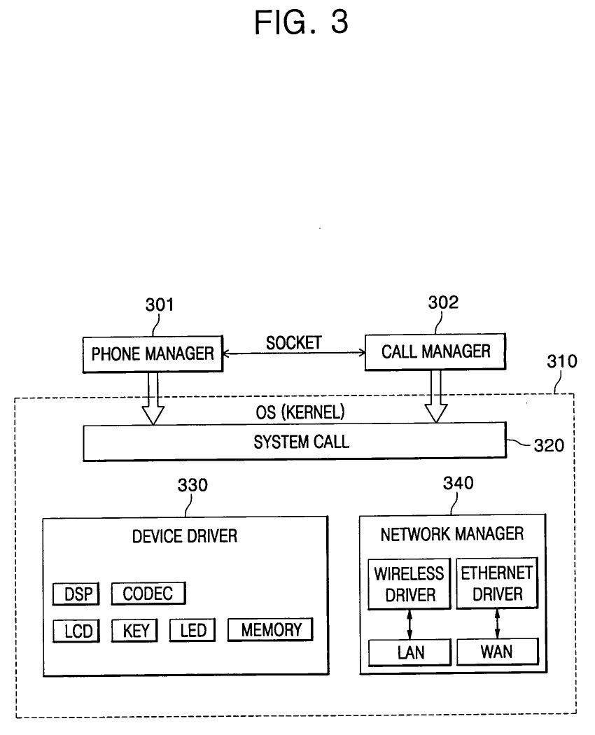

FIG. 3 is a block diagram of functions related to call process scheduling according to the present invention.

The communication terminal system of the present invention includes three processes (implemented in the form of a module) to control overall call process scheduling.

Each process include threads, and a communication between the processes is performed by a socket, and a communication between the threads in the processes is performed in an event driven manner via a message queue.

The process including a call module among the processes is referred to as a main process, and the main process includes call manager 302, Signaling Control Process (SCP), IP Proprietary (IPP), Wireless LAN Interface (WLI), and Media Gateway Interface (MGI) threads.

The SCP controls most of signals which come into the call manager.

The WLI participates in a signal process with a wireless LAN phone or a terminal having a wireless LAN card therein.

The IPP participates in a signal process used when wired and wireless voice and data received are transmitted via the Internet.

The MGI participates in a signal converting process between data and voice.

The call manager 302 module performs a task associated with call control with other threads in the main process and also performs a call control relating task together with other processes.

The call manager 302 also controls and processes a call using another message queue for control between respective call entities.

A process which performs a function of the telephone body is referred to as a phone manager 301.

The phone manager 301 module manages resources related to a voice, a handset, a speaker, a microphone, a Light Emitting Diode (LED), and a ring, and provides a socket communication with the call manager 302 which is in charge of a function related to call processing.

A message transmitted from the call manager 302 module invokes a function of a device driver 330, which is arranged below, to enable a voice, a handset call, a speaker call, a microphone, LED blinking, and a ringing service which are required for a telephone call.

The call manager 302 performs a task for call control with other threads, and also performs a task related to the call control together with other processes.

A message which comes into the call manager 302 undergoes an analysis process and then is converted to a message format which is prepared to process messages from different tasks.

The conversion is made by referring to a source task value of the message.

All messages which come into the call manager have a common structure of Table 1.

TABLE 1
typedef struct {

| | |
|---|---|
| unsigned char bHead | /*message header:0x7e */ |

| | |
|---|---|
| unsigned char bSys_flag | /*system flag:0x80 */ |

| | |
|---|---|
| unsigned char wPort | /*software port number */ |
| unsigned char wLength | /*total message length */ |

| | |
|---|---|
| unsigned char bDest_task | /*destination TaskID */ |
| unsigned char bSrc_task | /*source TaskID */ |

| | |
|---|---|
| unsigned char bMsg_id | /*message MainID */ |

The messages from different tasks are subjected to a call control task by different message handlers. A converted message format is used. In the keyphone, voice and data are processed by the above-described scheduling method.

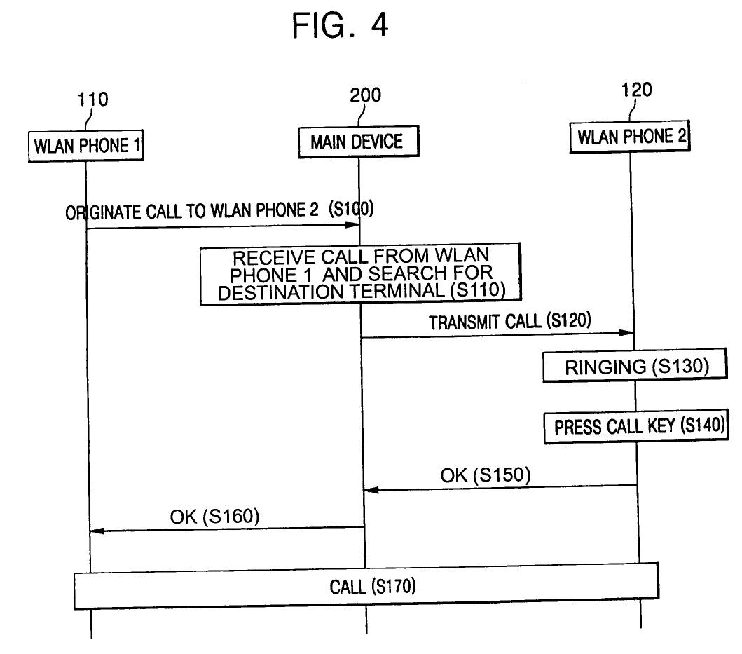

FIG. 4 is a view of an extension call method between wireless LAN phones according to an embodiment of the present invention.

Using a certain wireless LAN phone which is registered in the keyphone system, a user requests an extension call to another wireless LAN phone user in the same keyphone system.

It is assumed that the certain wireless LAN phone is a first wireless LAN phone 110, and the another wireless LAN phone is a second wireless LAN phone 120.

First, when the first wireless LAN phone 110 originates a call to the second wireless LAN phone 120 (S100), this signal is received by an AP of a keyphone main device 200.

The main device 200 identifies the received signal to search for a destination telephone terminal (S110).

The main device 200 transfers a call to the second wireless LAN phone 120 corresponding to a relevant extension number based on a searched number, and thus ringing, which is a call request signal, is generated in the second wireless LAN phone 120 (S130).

When the user of the correspondent second wireless LAN phone 120 presses a call key (or another key if it is set) for a telephone call (S140), an OK signal responsive to the call request is transferred to the first wireless LAN phone 110 (S150 and S160), thereby making call setup between the first wireless LAN phone 110 and the second wireless LAN phone 120 (S170).

Therefore, users in the same keyphone system can make an extension call via the wireless LAN phone, while securing mobility.

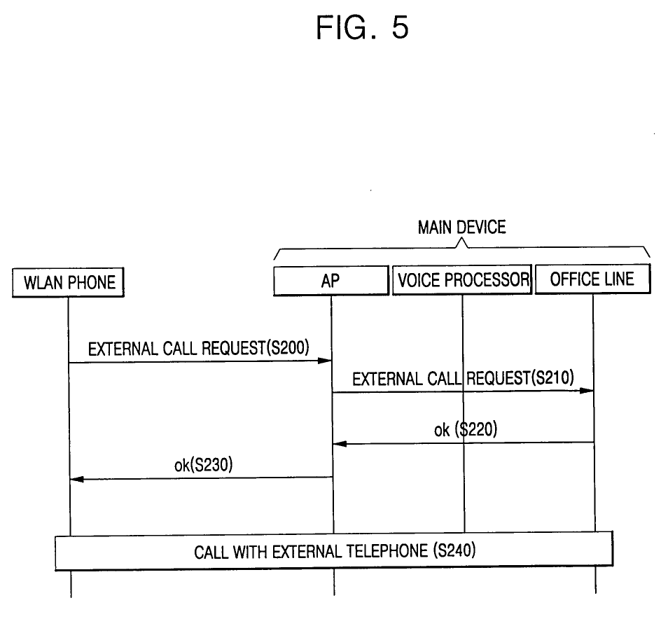

FIG. 5 is a view of a call method between a wireless LAN phone and an office telephone terminal via an office line according to an embodiment of the present invention.

Referring to FIG. 5, when a certain user originates an outgoing call using the wireless LAN phone (S200), an AP in a main device receives a call request signal and a DSP converts the call request signal to an analog line voice signal, and then makes an outgoing call request via the office line (S210).

When a call approval signal arrives concurrently with an hook-off of a destination telephone terminal via the office line (S220 and 230), the telephone call is established between the wireless LAN phone and an external telephone (S240).

In an embodiment of the present invention, since two office line jacks are arranged on a rear of the main device as shown in FIG. 1B, two channels for external calls can be supported. Of course, more channels can be secured by using a telephone terminal with a plurality of office line jacks.

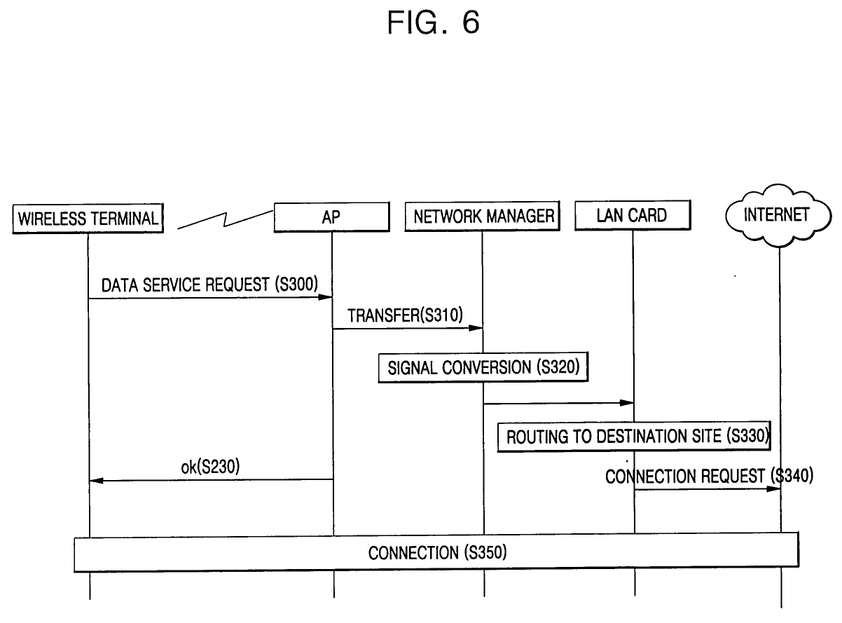

FIG. 6 is a view of a method of accessing the Internet using a wireless terminal having a wireless LAN card therein according to an embodiment of the present invention.

Referring to FIG. 6, when a wireless terminal (e.g., cellular phone, PDA, PC, etc.) which supports IEEE 802.11 a/b/g transmits a data service request signal (S300), the main device receives the data service request signal via the AP. The AP transfers data received via a PCI bus to a network manager which manages wired and wireless networks (S310).

The network manager converts the received signal to a signal which can be recognized by the wired network before transmitting the received signal to the Internet (S320).

The converted signal is routed to a destination site via the Ethernet port (S330), and an Internet connection is requested (S340).

If the connection with the destination site is established via the Internet (S350), then it is possible to transceives the data.

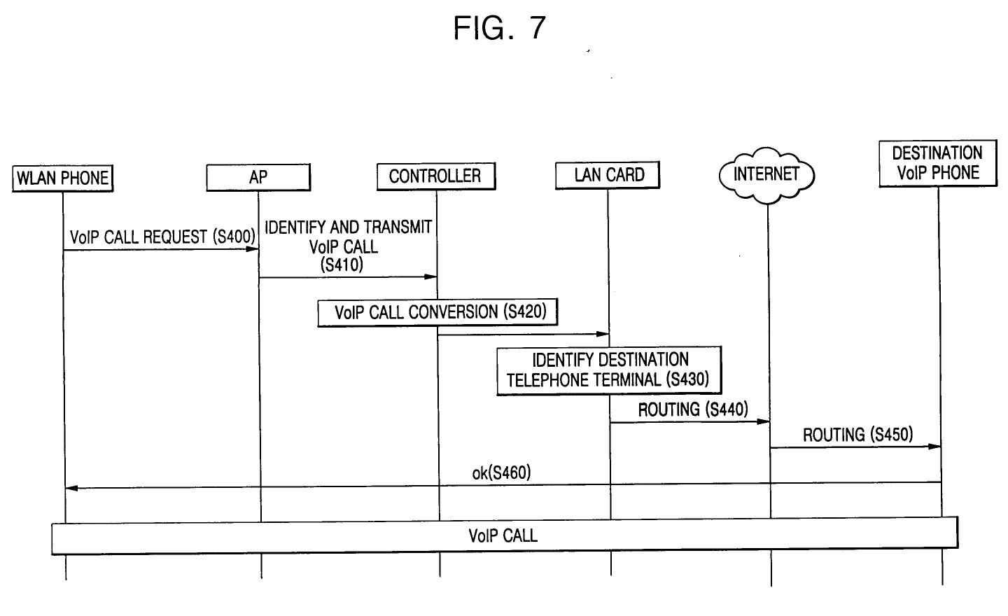

FIG. 7 is a view of a method of making a VoIP call in a keyphone system according to an embodiment of the present invention.

First, a user must subscribe to a VoIP service of a communication service provider. Then, when a certain user originates a VoIP call with a destination telephone number using the wireless LAN phone (S400), the main device receives the VoIP call request signal via the AP.

A signal for identifying the VoIP call is contained in the received VoIP call request signal and transferred (S410).

The VoIP call request signal is transferred to the controller via the PCI bus in the main device. The controller determines that it is a VoIP call and forwards the call to a wired LAN processor to transfer the call to the Internet (IP network) without using the office line port

The wired LAN processor determines an address of a destination telephone terminal (S430) and routs the call to a destination VoIP phone via the Internet (S440 and S450).

When the destination VoIP phone accepts the telephone call, an OK signal is transferred to the WLAN phone, making the VoIP call setup between the WLAN phone and the destination VoIP phone (S470).

Although it is described in FIG. 7 by way of example that the wireless LAN phone requests a VoIP call, the VoIP call can be also made by a telephone function of the main device.

The main device of the wireless keyphone system of the present invention further has a function of the telephone, and either the wireless LAN phone or the main device, or a PC (or notebook computer) supporting a VoIP call, i.e., a terminal supporting an H.323 protocol or a Session Initiation Protocol (SIP) can be provided with the VoIP service. This is because the network processor for the Internet service (using the IP network) is included in the main device.

As described above, according to the present invention, since the main device of one keyphone system has a small PBX function, the whole system is compact. Furthermore, since a communication between the main device and the sub phone is performed wirelessly, lines for telephones are unnecessary in offices, thereby the offices are clean.

Furthermore, it is possible to receive the VoIP service since the main device has the LAN card.

Although exemplary embodiments of the present invention have been described, it will be understood by those skilled in the art that the present invention is not limited to the described embodiments. Rather, various changes and modifications can be made within the spirit and scope of the present invention, as defined by the following claims.

What is claimed is:

1. A communication terminal system comprising:
at least one wireless terminal adapted to transmit and receive data to and from a main device via a wireless connection; and
the main device including:
an access point adapted to effect a wireless connection with the at least one wireless termninal;
a wireless data processor adapted to process data transceived via the access point;
a controller adapted to allow the transfer of data from the wireless data processor to a relevant processor depending on a kind of the data;
a voice processor adapted to transfer the data to a public switched telephone network upon a determination by the controller that the data is voice data; and
a wired data processor adapted to transfer the data to an Internet Protocol network upon a determination by the controller that the data is not voice data.

2. The system of claim 1, wherein the main device comprises:
a handset having a speaker and a microphone;
a display adapted to display the status of a telephone; and
keys adapted to transfer various function key inputs to a main board of the main device;
wherein the main device is adapted to have a wired telephone function of enabling a telephone call by receiving and transmitting a data signal.

3. The system of claim 2, wherein the wireless data processor of the main device and the wireless terminal support IEEE 802.11 a/b/g.

4. The system of claim 3, wherein the wireless terminal comprises one of a wireless local area network phone, a computer having a wireless local area network card therein, and a personal digital assistant.

5. The system of claim 1, wherein the main device further comprises a network processor and an Ethernet port adapted to effect an Internet connection.

6. The system of claim 5, wherein the main device further comprises an Ethernet port for a computer, the Ethernet port adapted to receive an Internet service accessed via the Ethernet port.

7. The system of claim 1, wherein the main device comprises:
a main board including:
a controller adapted to control the entire system and signal process scheduling;
a processor adapted to perform signal processing for each device;
an interface adapted to transfer a signal between the respective processors;
a wireless local area network card adapted to process data transceived via the access point;
a wired local area network card adapted to process data transceived via an Ethernet port; and
a memory adapted to store data;
a keypad board adapted to scan a key value depending on a key button input and to transfer the scanned key value to the main board; and
a display adapted to process a signal to display current status information of a telephone.

8. The system of claim 7, wherein the main board controller comprises:
a call manager module adapted to perform a task for call control;
a phone manager module adapted to manage resources of the telephone, a handset, a speaker, and a microphone to perform an overall function of a telephone and to transfer a message between the call manager module and a user interface module; and
an operating system kernel module including an interrupt processor, a scheduler, and a supervisor and adapted to invoke a program function of a relevant device.

9. The system of claim 8, wherein the call manager module is adapted to control respective call entities in a message queue manner.

10. The system of claim 9, wherein the call manager module is adapted to receive a message from a message queue, analyze and convert the received message into a relevant message format and then transfer the analyzed converted message to a next message queue.

11. The system of claim 10, wherein the call manager module is adapted to convert the message into a message format defined in a source task value in the message by referring to the source task value to process messages from different tasks, and then to be controlled by different message handlers.

12. A communication terminal system comprising:
at least one wireless local area network phone adapted to transmit and receiving data to and from a main device via a wireless connection; and
the main device including:
an access point for the wireless connection with the wireless local area network phone;
a wireless data processor adapted to process data transceived via the access point;
a digital signal processor adapted to convert data transceived via the wireless data processor into a voice signal or vice versa;
an analog circuit adapted to transfer the converted signal to an office line; and
at least one office line port.

13. The system of claim 12, wherein the main device comprises:
a handset having a speaker and a microphone;
a display adapted to display the status of a telephone; and
keys adapted to transfer various function keys to a main board of the main device;
wherein the main device is adapted to have a wired telephone function of transceiving a data signal therein to perform a telephone call.

14. The system of claim 12, wherein the wireless data processor of the main device and the wireless local area network phone are adapted to support IEEE 802.11 a/b/g.

15. The system of claim 12, wherein the main device further comprises a network processor and an Ethernet port, the Ethernet port adapted to effect an Internet connection.

16. The system of claim 15, wherein the main device further comprises an Ethernet port for a computer, the Ethernet port adapted to provide an Internet service via the Ethernet port.

17. The system of claim 12, wherein the main device comprises:
a main board including;
a controller adapted to control the whole system and whole signal process scheduling;
a processor adapted to perform signal processing for each device;
an interface adapted to transfer a signal between the respective processors;
a wireless local area network card adapted to process data transceived via the access point;
a wired local area network card adapted to process data transceived via an Ethernet port; and
a memory adapted to store data;
a keypad board adapted to scan a key value depending on a key button input and to transfer the scanned key value to the main board; and
a display adapted to process a signal to display current status information of a telephone.

18. The system of claim 17, wherein the main board controller comprises:
a call manager module adapted to perform a task for call control;
a phone manager module adapted to manage resources of the telephone, a handset, a speaker, and a microphone to perform an overall function of the telephone and to transfer a message between the call manager module and a user interface module; and
an operating system kernel module including an interrupt processor, a scheduler, and a supervisor and adapted to invoke a program function of a relevant device.

19. The system of claim 18, wherein the call manager module is adapted to control respective call entities in a message queue manner.

20. The system of claim 19, wherein the call manager module is adapted to receive a message from a message queue, analyze and convert the received message into a relevant message format and then transfer the analyzed converted message to a next message queue.

21. The system of claim 20, wherein the call manager module is adapted to convert the message into a message format defined in a source task value in the message by referring to the source task value to process messages from different tasks, and then is controlled by different message handlers.

22. A signal control method comprising:
receiving, by a call manager, a message coming from at least one of a wireless terminal, a wired telephone arranged in a main device, and a computer connected to a wired Ethernet port;
analyzing and converting the received message into a relevant message format; and
calling, by the converted message, a relevant message handler to perform a relevant operation.

23. The method of claim 22, further comprising, upon the message received by the call manager being a task for a wireless extension call request:
receiving an extension call request signal from a certain wireless local area network phone via an access point of the main device;
searching a terminal corresponding to a destination extension number of the call received via the access point;
transmitting a call request signal to the relevant destination wireless local area network phone upon the destination terminal being searched;
outputting a ringing signal from the destination wireless local area network phone;
transmitting a connection approval signal to the wireless local area network phone which requested a call upon a user pressing a button to approve the call; and
establishing the call between the call request wireless local area network phone and the destination wireless local area network phone after transmitting the connection approval signal.

24. The method of claim 22, further comprising, upon the message received by the call manager being a task for an external call request from the wireless terminal:
receiving an external call request signal from a certain wireless local area network phone via an access point of the main device;
transmitting a call request to a destination telephone terminal via an office port not occupied by other telephone terminals to transfer the call received via the access point to a public switched telephone network;
transmitting a connection approval signal to the call request wireless phone upon a user pressing a button to approve the call; and
establishing the call between the call request wireless local area network phone and the destination telephone terminal after transferring the call approval signal from the destination telephone terminal.

25. The method of claim 22, further comprising, upon the message received by the call manager being a task for a data service request from the wireless terminal:
receiving a data service request signal from a certain wireless terminal via an access point of the main device;
transferring the data service request signal received via the access point to a network manager before connecting to the Internet;
converting, by the network manager, the received signal from the wireless terminal to a signal which is recognizable on a wired network before transmitting to the Internet; and
routing the converted signal to a destination site via an Ethernet processor.

26. The method of claim 25, further comprising:
attempting a connection request for connection to the relevant destination site after routing the converted signal to the destination site; and
establishing the connection between the wireless terminal and the destination site upon the connection being approved.

27. The method of claim 22, further comprising, upon the message received by the call manager being a task for a voice over Internet protocol call request from the wireless terminal:
receiving a voice over Internet protocol call request signal from a certain wireless local area network phone via an access point of the main device; transferring the voice over Internet protocol call request signal received via the access point to a controller of the main device;
determining, by the controller, whether or not the received signal is for the voice over Internet protocol call; and
routing, by an Ethernet processor, the voice over Internet protocol call to a destination voice over Internet protocol phone via the Internet upon the received signal being for the voice over Internet protocol call.

28. The method of claim 27, further comprising transmitting, by the access point, an identifier informing the controller that the received signal is for the voice over Internet protocol call after receiving the voice over Internet protocol call request signal from the certain wireless local area network phone via the access point of the main device.
